(19) United States
(12) Patent Application Publication
(10) Pub. No.: US 2015/0206671 A1
(43) Pub. Date: Jul. 23, 2015

(54) ELECTRONIC DEVICE WITH BUTTON

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: LI-JUN YANG, Shenzhen (CN)

(21) Appl. No.: 14/498,244

(22) Filed: Sep. 26, 2014

(30) Foreign Application Priority Data
Jan. 22, 2014 (CN) 2014100283797

(51) Int. Cl. H01H 13/14

(52) U.S. Cl. CPC H01H 13/14

(57) ABSTRACT

An electronic device having a surface-mounted pressable button includes a shell, a pressing piece, a fixing piece, an adjusting piece, and a switch. The shell defines a receiving hole. The pressing piece is movably received in the receiving hole. The fixing piece is fixed in the electronic device and defines a first through hole facing the pressing piece. The adjusting piece is received in the first through hole and is movable along an axis of the first through hole. The switch faces the pressing piece and is fixed to the adjusting piece, and the depth of the switch within the first through hole is adjustable.

### CROSS-REFERENCE TO RELATED APPLICATIONS

This application claims priority to Chinese Patent Application No. 201410028379.7 filed on Jan. 22. 2014, in the China Intellectual Property Office, the contents of which are incorporated by reference herein.

### FIELD

The present disclosure relates to switching technology in electronic devices.

### BACKGROUND

Electronic devices include a housing and buttons fixed to the housing. The housing defines a receiving space to receive electronic elements. One end of the buttons are exposed out of the housing to be pressed by a user, and the other end of the buttons are received in the receiving space to activate an electronic element of the electronic device.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an embodiment of an electronic device.

FIG. 2 is a cross-sectional view taken along the line II-II of FIG. 1.

FIG. 3 is an exploded, isometric view of the electronic device in FIG. 1.

FIG. 4 is similar to FIG. 3, but viewed from another angle.

### DETAILED DESCRIPTION

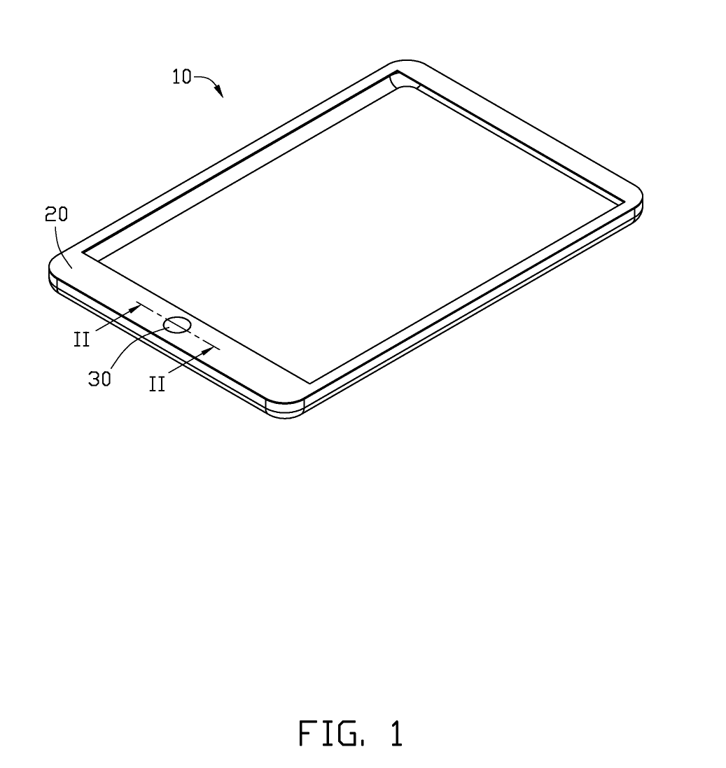

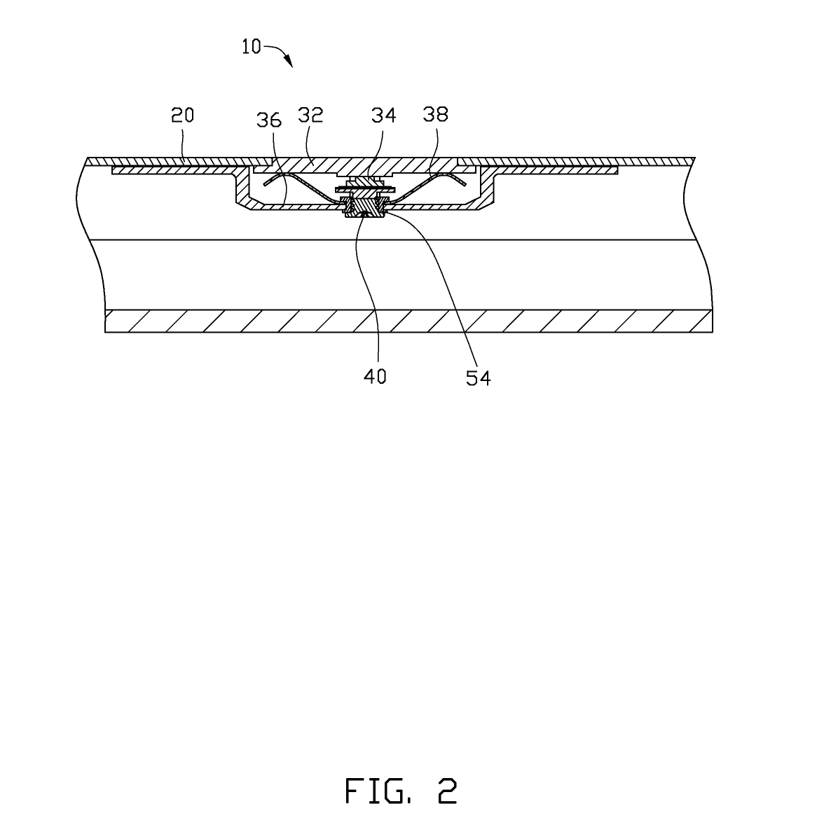

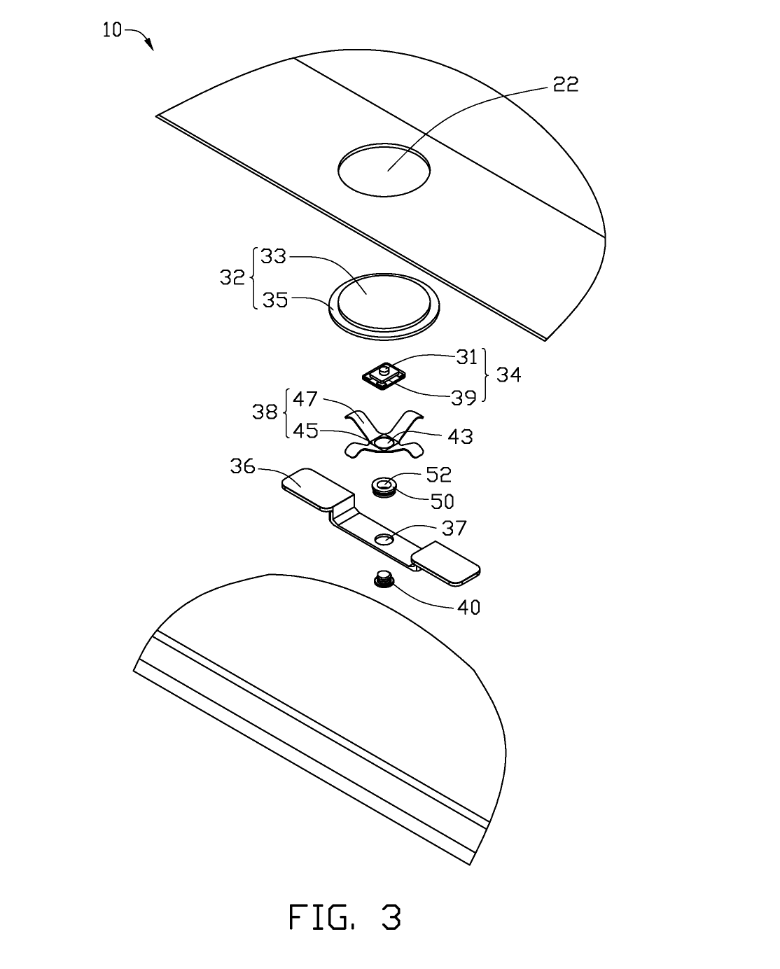

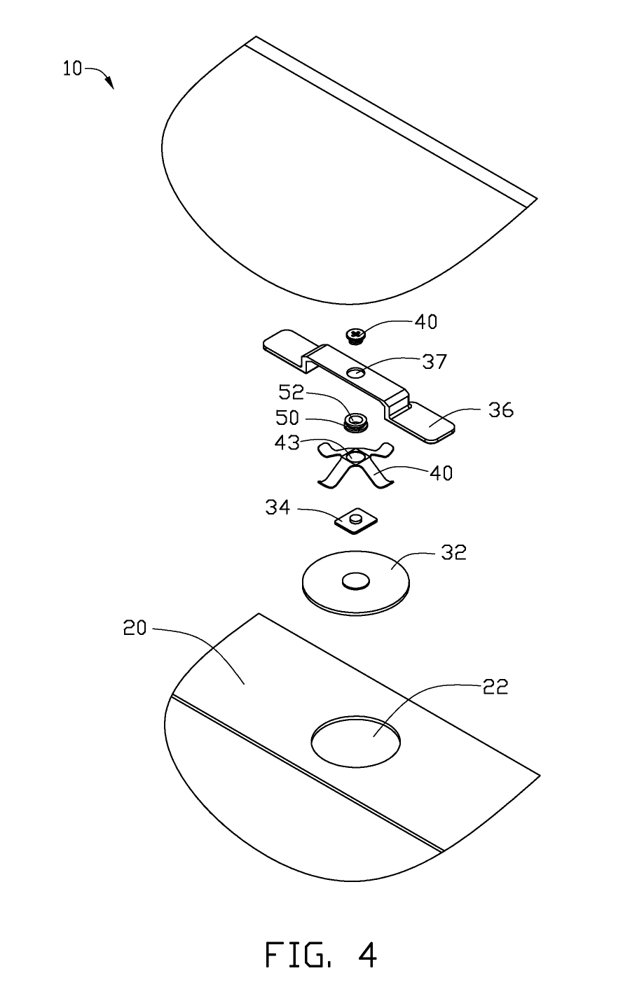

FIGS. 1-4 illustrate an electronic device 10. The electronic device 10 comprises a shell 20 and a button 30. The shell 20 defines a receiving hole 22. The button 30 includes a pressing piece 32, a switch 34, a fixing piece 36, an elastic piece 38, and an adjusting piece 40.

The pressing piece 32 is movably received in the receiving hole 22 and configured to activate the switch 34. In at least one embodiment, the pressing piece 32 includes a pressing portion 33 and a blocking portion 35 protruding from the pressing portion 33. The pressing portion 32 is received in the receiving hole 22. The blocking portion 35 is positioned at an inside of the shell 20 to hold the pressing portion 32 captive in the shell 20.

The fixing piece 36 is fixed in the electronic device 10 and defines a first through hole 37. In at least one embodiment, the fixing piece 36 is fixed to the shell 20. The adjusting piece 40 is received in the first through hole 37. The adjusting piece 40 is movable back and forth along the axis of the first through hole 37. In at least one embodiment, the first through hole 37 defines spiral burrs. The adjusting piece 40 is a bolt. The bolt can engage with different spiral burrs of the first through hole 37. Thus, the bolt can move along the axis of the first through hole 37.

The switch 34 is arranged between the adjusting piece 40 and the pressing piece 32. The switch 34 includes a trigger 31 and a holder 39 fixed to the trigger 31. The trigger 31 is electrically connected to a main board (not shown) and faces the pressing piece 32. The trigger 31 is configured to activate the switch 34 when the pressing piece 32 is pressed. The holder 30 is fixed to the adjusting piece 40. Thus, the depth or position of the holder 39 is adjustable in the pressing direction through a movement of the adjusting piece 40 along the axis of the first through hole 37. Therefore, no matter the tolerances between the switch 34, the shell 20, and the pressing piece 32, the pressing piece 32 can always be made to touch the shell 20 and the switch 31, and recognition of the pressing piece 32 by the fingertips only is always easily obtained. In at least one embodiment, the holder 39 is adhered to the adjusting piece 40. A part of the holder 39 is received in the first through hole 37. Thus, any radial movement of the holder 39 within the first through hole 37 is restricted.

The elastic piece 38 is configured to provide force to restore the pressing piece 32 when pressure on the pressing piece 32 is relaxed. In at least one embodiment, a first end of the elastic piece 38 touches the pressing piece 32, and a second end of the elastic piece 38 touches the fixing piece 36. The shape of the elastic piece 38 resembles the petals of a flower, and includes a bottom portion 45 and a plurality of tips 47. The plurality of tips 47 extend from the bottom portion 45 to the pressing piece 32. The plurality of tips 47 each touch the edge of the pressing piece 32 at equal intervals.

In at least one embodiment, the button 30 further includes a steady piece 50. The steady piece 50 defines a second through hole 52 and defines an annular groove 54 at the external surface of the steady piece 50. The bottom portion 45 defines a third through hole 43 communicating with the first through hole 37. The fixing piece 36 is sleeved in the annular groove 54 through the first through hole 37. The elastic piece 38 is sleeved in the annular groove 54 through the third through hole 43. Therefore, a movement of the elastic piece 38 radially within the first through hole 37 is restricted.

It is understood that the present disclosure may be embodied in other forms without departing from the scope thereof. Thus, the present examples and embodiments are to be considered in all respects as illustrative and not restrictive, and the disclosure and the following are not to be limited to the details given herein.

What is claimed is:

1. An electronic device comprising:
a shell defining a receiving hole;
a pressing piece movably received in the receiving hole;
a fixing piece fixed in the electronic device and defining a first through hole facing the pressing piece;
an adjusting piece received in the first through hole and movable along an axis of the first through hole; and
a switch facing the pressing piece and fixed to the adjusting piece, and where the switch is positioned is adjustable when the adjusting piece moves along the axis of the first through hole.

2. The electronic device as claimed in claim 1, wherein the first through hole defines spiral burrs, the adjusting piece is a bolt, and the bolt engages with the spiral burrs.

3. The electronic device as claimed in claim 1, further comprising an elastic piece, the elastic piece abutting against the pressing piece, when the pressing piece is pressed, the switch is activated, the elastic piece configured to restore the pressing piece when the pressing piece is relaxed.

4. The electronic device as claimed in claim 3, wherein the pressing piece comprises a pressing portion and a blocking portion protruding from the pressing portion, the pressing portion is received in the receiving hole, the blocking portion is positioned at an inside of the shell, and the elastic piece is positioned below the blocking portion.

5. The electronic device as claimed in claim 3, wherein the elastic piece comprises a bottom portion and a plurality of tips extending from the bottom portion to the pressing piece, and the plurality of tips touch the edge of the pressing piece at equal intervals.

6. The electronic device as claimed in claim 5, wherein the shape of the elastic piece resembles the petals of a flower.

7. The electronic device as claimed in claim 5, wherein the bottom portion abuts against the fixing piece.

8. The electronic device as claimed in claim 7, further comprising a steady piece, the steady piece defining a second through hole and defining annular grooves at the external surface of the steady piece, the bottom portion defines a third through hole communicating with the first through hole, the fixing piece is sleeved in the annular groove through the first through hole, and the elastic piece is sleeved in the annular groove through the third through hole.

9. The electronic device as claimed in claim 1, wherein the switch comprises a trigger and a holder fixed to the trigger, the trigger is configured to activate a function of the electronic device, and a part of the holder is received in the first through hole.

10. The electronic device as claimed in claim 9, wherein the holder is adhered to the adjusting piece.

11. An electronic device comprising:
a shell defining a receiving hole;
a pressing piece movably received in the receiving hole;
a fixing piece fixed in the electronic device and defining a first through hole facing the pressing piece;
an adjusting piece movably fixed in the first through hole; and
a switch fixed to the adjusting piece and being activated when the pressing piece is pressed, and where the switch is positioned at the pressed direction is varied with a movement of the adjusting piece in the first through hole.

12. The electronic device as claimed in claim 11, wherein the first through hole defines spiral burrs, the adjusting piece is a bolt, and the bolt engages with the spiral burrs.

13. The electronic device as claimed in claim 11, further comprising an elastic piece, the elastic piece abutting against the pressing piece, the elastic piece configured to restore the pressing piece when the pressing piece is relaxed.

14. The electronic device as claimed in claim 13, wherein the pressing piece comprises a pressing portion and a blocking portion protruding from the pressing portion, the pressing portion is received in the receiving hole, the blocking portion is positioned at an inside of the shell, the elastic piece is positioned below the blocking portion.

15. The electronic device as claimed in claim 13, wherein the elastic piece comprises a bottom portion and a number of tips extending from the bottom portion to the pressing piece, the number of tips touch the edge of the pressing piece at equal intervals.

16. An electronic device comprising:
a shell having a receiving hole;
a pressing piece movably received in the receiving hole;
a fixing piece fixed in the electronic device and defining a first through hole facing the pressing piece;
an adjusting piece received in the first through hole and movable along an axis of the first through hole; and
a switch facing the pressing piece and adjustably fixed to the adjusting piece, the switch adjustable by movement of the adjusting piece along the axis.

17. The electronic device as claimed in claim 16, wherein the first through hole defines spiral burrs, the adjusting piece is a bolt, and the bolt engages with the spiral burrs.

18. The electronic device as claimed in claim 16, further comprising an elastic piece, the elastic piece abutting against the pressing piece, the elastic piece configured to restore the pressing piece when the pressing piece is relaxed.

19. The electronic device as claimed in claim 18, wherein the pressing piece comprises a pressing portion and a blocking portion protruding from the pressing portion, the pressing portion is received in the receiving hole, the blocking portion is positioned at an inside of the shell, the elastic piece is positioned below the blocking portion.

20. The electronic device as claimed in claim 18, wherein the elastic piece comprises a bottom portion and a number of tips extending from the bottom portion to the pressing piece, the number of tips touch the edge of the pressing piece at equal intervals.
